(19) United States
(12) Patent Application Publication
(10) Pub. No.: US 2007/0127423 A1
(43) Pub. Date: Jun. 7, 2007

(54) Server and mobility management for scalable multimedia quality of service (QoS) communication

(75) Inventor: David Chia-Chen Ho, Cupertino, CA (US)

Correspondence Address: Bo-In Lin, 13445 Mandoli Drive, Los Altos Hills, CA, 94022, US

(73) Assignee: AnQ Systems, Ltd.

(21) Appl. No.: 11/412,768

(22) Filed: Apr. 27, 2006

Related U.S. Application Data
(60) Provisional application No. 60/742,060, filed on Dec. 2, 2005.

(51) Int. Cl. H04Q 7/24

(52) U.S. Cl. 370/338; 455/433

(57) ABSTRACT

The present invention discloses a method for providing a client-requested location dependent information for a designated location through a wireless communication system. The method includes a step of detecting a presence of a wireless network client at the designate location by the wireless communication system wherein the wireless communication system includes a data record of client profile to enable a determination if there is such a client-requested location dependent information for the designated location from the user whereby the client-requested location dependent information may be provided to the client at the designated location through the wireless communication system.

This application is a Formal application and claims a Priority Filing Date of Dec. 2, 2005 benefited from a previously filed Application 60/742,060 filed previously by the inventor of this Patent Application.

### BACKGROUND OF THE INVENTION

1. Field of the Invention

This invention relates generally to communication networks. More particularly, this invention is related to a new and improved system configuration and user connection management processes among several layers communication network.

2. Description of the Prior Art

Even though technologies in wireless communications have made tremendous advancement recently, conventional wireless system providers and equipment vendors are still confronted with several technical difficulties and limitations. Specifically, conventional wireless systems are still implemented with a “switch based” technological approach. As will be further discussed below, the switch-based systems present several technically challenging difficulties that limit the system performance.

Referring to FIG. 1 for a conventional wireless communication system. The system includes a backend server control a standard switch for switching signals transmission between several standard thin AP, e.g., standard thin AP1, AP2, AP3, and AP4. Each standard thin AP then serves signal communication with wireless clients. Such system has the advantages that it has no coverage limitation and may deploy over vast areas because the existing wired network including L2/L3 switches and routers that allows vast area coverage. Furthermore, the deployment may be based on existing wired networks because the deployment is based on the L2/L3 switches. The system architecture further provides the benefits of a centralized and simplified management. However, the service to the wireless clients suffers several limitations. The system cannot provide to the clients a mobile quality of service (QoS) due to the difficulties to provide all the classification rules among the various L2 and L3 switches to support the QoS services for the mobile users. The wireless communication is further unreliable due to its vulnerability to a single point failure. Finally, the system can only provide limit throughput for large networks due to the lack of scalable data structure to support system expansion and further compounded by the problems that the single backend server would certainly become a bottleneck for scaling up the system to serve an expanded system.

FIG. 2 shows another conventional system architecture of a communication network. Again, a single backend server function as a management server is implemented to control wireless switch. The wireless switch then interfaces and controls a plurality of standard thin AP to transmit signals to the wireless clients. This system resolves the issue of throughput limitations by expanding the throughput capacity because the dedicated switch will provide better throughput for the network that connect to the switch. However, such system architecture suffers the limitation that the system is adjunct to the existing switches. The wireless network is connected to separate and dedicated switches that lead to two sets of switches implemented in the system. Additional complications and difficulties are added when the system has to operate with two sets of switches one of the existing network and one for the wireless network. The system further has the difficulties that it is difficult to cover large area due to the difficulties that the dedicated wireless switches are less flexible to be scalable. The dedicated switches are also more difficult to process the roaming or handover operations between two switches. This system is therefore difficult to manage multiple SW because without central management architecture, it is difficult to have mobile users roaming or handover between switches. Therefore, the communication handover when a client roams from one switch to a different switch becomes much more difficult to process and manage. The SW further has limited intelligence thus limiting the scalability capability of the system. Similar to the system shown in FIG. 1, this system is also vulnerable to a single point failure and become unreliable without fault single point failure tolerance. The requirements of proprietary SW and AP as typically implemented in such systems further increase the cost of implementation of such systems.

FIG. 3 shows another conventional system architecture of a communication network. The system is again implemented with a single backend server function as a management server to control wireless switch. The wireless switch then interfaces and controls a plurality of intelligent thin APs to transmit signals to the wireless clients. This system has the advantage that potential mesh capability is a feasible option. The mesh capability provides the advantages that multiple APs can cover larger areas with Ethernet cable connections. This system also has the option to connect to the existing switch because the AP has certain intelligence to operate and able to connect to the existing network switches. However, such system architecture suffers the limitation that it is difficult to manage the processes when a wireless client is roaming from an AP to a different AP. Furthermore, the distributed intelligent AP configuration complicates the design, maintenance, scalability and management of the whole system. Additionally, the intelligent AP as implemented has only limited intelligence and that causes further difficulties of traffic bottleneck at these APs due to the limited intelligence. In order to implement the intelligent AP, the system becomes more expensive due to a requirement to implement the distributed proprietary AP. Similar to other conventional system architecture, the system again is vulnerable to a single point failure.

As most of the conventional wireless systems as discussed above are switch based, a basic problem is the caused by difficulties that the intelligence of a network communications available and processed by a switch is difficult to migrate to another switch. The mobility, scalability, quality of service (QoS) performance and the system reliability all suffer due to these difficulties. For these reasons, a requirement still exist in the art of wireless network communication to provide new and improved systems configurations and information process algorithms such that the above discussed problems and limitations can be resolved.

### SUMMARY OF THE PRESENT INVENTION

An aspect of the present invention is to advance the technology of wireless communication by providing new and improved system architecture with more reliable and more flexible communication data management and distributions such that the above discussed problems; limitations and difficulties may be resolved.

One aspect of the invention is to provide new and improved wireless network communication systems that are more flexibly scalable such that the system is able to manage wireless communication between multiple thousands of subscribers. The central management servers (master and slave) provide the AP & subscribers information to the distributed local servers. The distributed local servers then provide the connectivity to various networks. There can be tens and hundreds of local distributed servers. Most importantly, the QoS and security service are transparent to mobile users from local server to local server.

Another aspect of the invention is to provide new and improved wireless network communication systems that can more flexibly and effectively handle mobility of subscribers who are moving between different base stations functioning as access points (APs). The new and improved wireless communication systems of this invention can effectively manage the detection and management of logging-in processes of the subscribers into different subnets such that the subscribers have continuous and seamless transitions when travel from one region to another.

Another aspect of the invention is to provide new and improved wireless network communication systems that can handle end-to-end quality of service (QoS) and also the billing services. A new QoS technology is disclosed in this invention that offers end-to-end QoS and seamless mobile devices and users roaming, monitoring, bandwidth control, capacity load balance, and billing management. The central management servers provide the subscriber's information to the distributed local servers. This distributed mobile user data allow the local server provide consistent service in various environments.

Another aspect of the invention is to provide new and improved wireless network communication systems that can more effectively handle the load balances to assure QoS services are provided to the subscribers. Such QoS quality often becomes a difficult task due the situations that a traffic congestion occurs due to a large number of wireless users or devices are increased in a short of time at an unpredictable location. The present invention provides effective traffic control and load balance management such that QoS quality of services can be maintained thus provide effective solutions to overcome the limitations and difficulties as that encountered in the conventional technologies.

Briefly, the present invention discloses a wireless communication system includes multiple data handling system for processing network connections and data transmissions. The wireless communication system further includes a centralized data handling system for dynamically and intelligently distributing a user profile data record to one of the data handling systems for each of the data handling system to process the network connections and data transmission for a user designated by the user profile data record.

In an alternate embodiment, this invention discloses a method for providing a client-requested location dependent information for a designated location through a wireless communication system. The method includes a step of detecting a presence of a wireless network client at the designate location by the wireless communication system wherein the wireless communication system includes a data record of client profile to enable a determination if there is such a client-requested location dependent information for the designated location from the user whereby the client-requested location dependent information may be provided to the client at the designated location through the wireless communication system.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1-3 are functional block diagrams for showing the system configurations of conventional architecture for the formation of the wireless network communications.

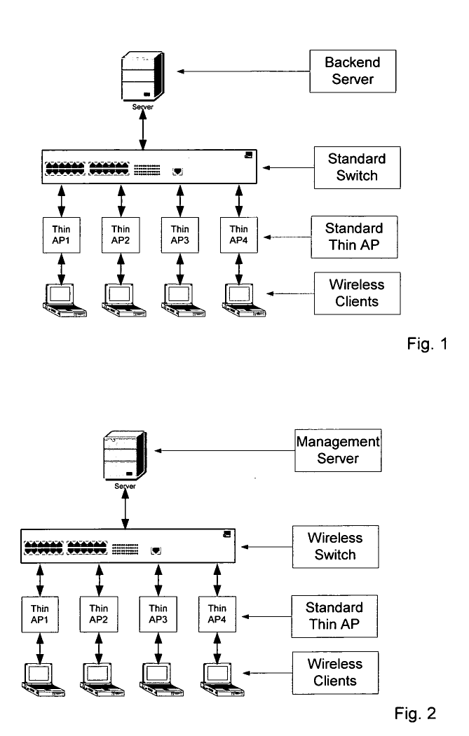

FIG. 4. is a functional block diagram showing the architecture of a wireless communication network of this invention.

FIG. 5 is system diagram for showing different level of network information processes and transmissions to handling and managing the wireless communications.

FIG. 6 is a data flow diagram for illustrating the wireless mobility management according to a preferred embodiment of this invention.

FIG. 7 is a system diagram for showing a wireless local loop integrated into a metro network according to another preferred embodiment of this invention.

FIG. 8 is a flowchart for showing the algorithm of load balance management.

FIG. 9 content delivery system enabled by the WLAN systems as disclosed in this invention.

FIG. 10 is a functional diagram for illustrating the cooperation relationships between the content provider, the commercial network operator and the mobile user for content delivery.

### DETAILED DESCRIPTION OF THE PREFERRED EMBODIMENT

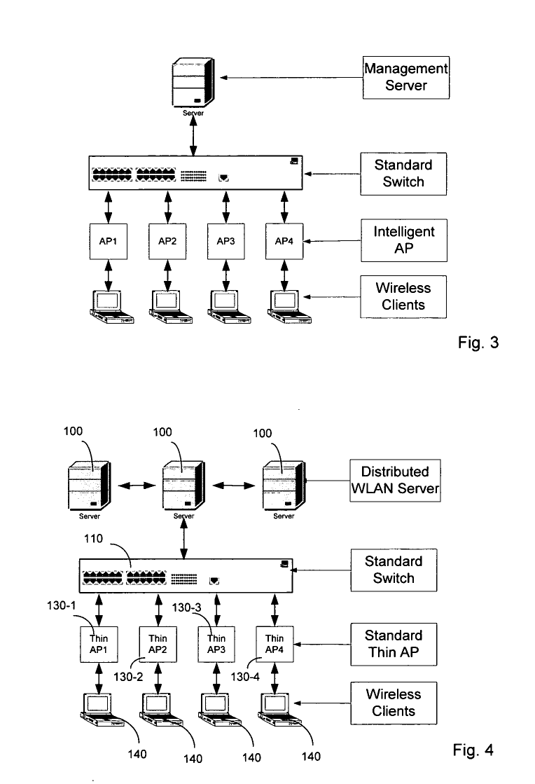

FIG. 4 depicts a typical networking infrastructure of this invention based on a distributed content sensitive backend server implemented to process the mobility management. The network infrastructure includes a plurality of distributed wide-area local area network (WLAN) servers 100 connected to a standard switch 110. The standard switch 110 is then connected to several standard thin access points (APs), e.g., 130-1, 130-2, 130-3 and 130-4, and each thin AP then handles and processes a group of wireless clients 140. As will be further discussed below, this new and improved network architecture provides several advantages. The wireless communication network as shown constitutes an specially advantageous “one network” architecture that can be seamlessly added to existing wired network with standard switches and APs. This network configuration further enhances the mobility and traffic managements and provides robust mobile quality of service (QoS) performance. Because of the standard switches and APs and the distributed personal-computer (PC) based servers, the network infrastructure as shown provides unlimited scalability with fail-over and redundancy fault tolerant protection to assure highly system reliability and high availability of services are achieved. The distributed configuration further simplified the operations of load balance to handle special high volume of signals. With the standard switch and AP and the PC-based servers, the system can be easily upgraded and conveniently merged into different networks. Furthermore, the system configuration as shown are highly cost competitive because of the standard communication and data handling systems implemented at different levels to construct the network infrastructure.

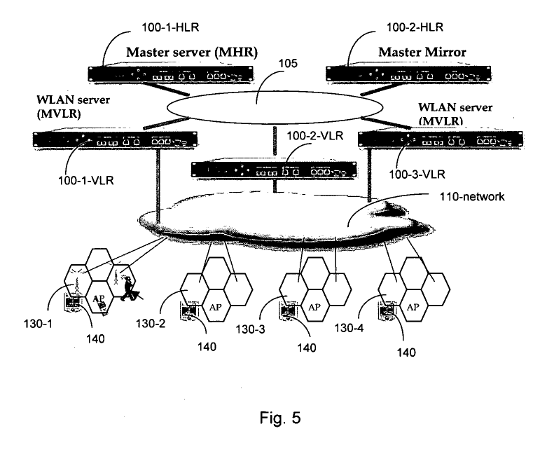

Referring to FIG. 5 for a functional block diagram for illustrating a more detail system architecture to implement the system configuration as that shown in FIG. 4. The wireless local area network (WLAN) system includes a master server 100-1-HLR and backup master mirror 100-2-HLR together with WLAN servers 100-1-VLR, 100-2-VLR, and 100-3-VLR to function as the PC based server 100 as that shown in FIG. 4. The backup mirror server 100-2-HLR improves the reliability of the system. The master servers 100-1-HLR and 100-2-HLR are connected through a wired or wireless system 105 to the plurality of WLAN servers 100-1-VLR, 100-2-VLR, 100-3-VLR, etc. Each of these master servers 100-HLR and 100-VLR can be combined for smaller WLAN network systems or separately implemented as two levels of servers as shown in FIG. 5 for larger network systems. These switches, e.g., 110-1, 110-2, and 110-3 are implemented in the switchable communication networks 110-network to be in active communications with a plurality of access points (APs), e.g., AP 130-1, 130-2, 130-3, and 130-4 and each AP serves a plurality of wireless clients 140. The WLAN servers 100-HLR or 100-VLR store the home location records (HLR) and the visitor location records (VLR) as will be further discussed below.

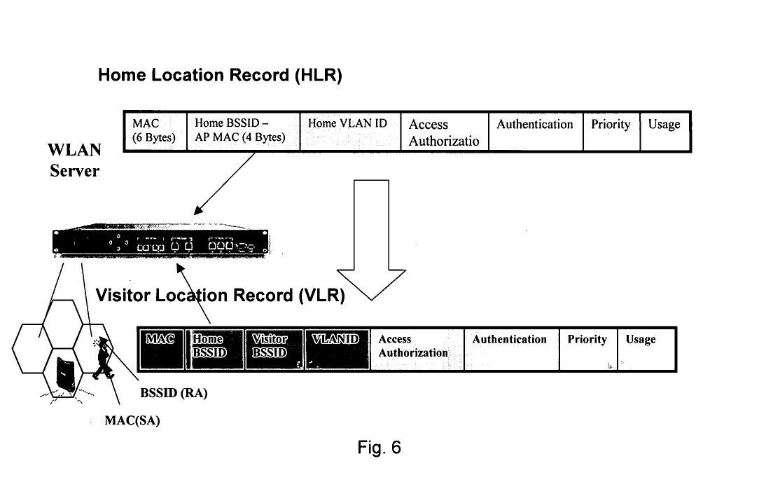

FIG. 6 shows the data structures and information provided in the HLR and VLR to carry out the tasks of mobility management. The master servers 100-1-HLR with the mirror backup server 100-2-HLR store the mobile home location record (HLR) that may be implemented as a layer-7 record. The HLR includes mobile user's personal data including Mobile wireless device MAC data. The MAC data includes Mac addresses (48 bits) and these addresses are used as key when searching the Home Location Register (HLR) entry. One mobile user can have more than one wireless device such as Laptop computer, personal digital data assistant (PDA), and Wi-Fi phone. Therefore, this field for entry of the mobile wireless device MAC data can have more than one entry each designates a specific wireless mobile device. Additional personal information includes the mobile user name, the mobile user address, the mobile user phone number when a voice feature is enabled, and the mobile user identification number, e.g., the user ID. The HLR record further includes mobile cell data such as the mobile device Basic Service Set Identification/Identifier (BSSID), the mobile device home Extended Service Set Identification/Identifier (ESSID), and optionally the home VLAND ID associates a frame with a specific VLAN and provides the information that switches need to process the frame across the network.

The name assigned to a wireless network is what shows up when a wireless client displays available networks. Many manufacturers use the terms “SSID” or “BSSID” in place of network name. Group multiple BSSID can be an ESSID. The Extended Service Set Identification (ESSID) is one of two types of Service Set Identification (SSID). An Ad-hoc wireless network with no access points uses the Basic Service Set Identification (BSSID). In an infrastructure wireless network that includes an access point, the Extended Service Set Identification (ESSID) is used—although it may still be referred in a loose sense as SSID. Some vendors refer to the SSID as the “network name”.)

The HLR record further includes data for access authorization to provide mobile user security access information. The access authorization information includes the access privilege that may include privilege of high, normal and visitor privileges. The access authorization information further includes accessible zone areas, such as accessible in all zones, in limited zones with assessable zone Ids. The access authorization information further includes allowable access applications, such as data access, data access for voice communications, and multimedia access for transmission of multimedia data.

The mobile home location record (HLR) further includes mobile user quality of service (QoS) information that includes user types and the rate for each user type. Possible user types may include types of different rates such as Premium rate, Guarantee rate, and Best Efforts rate. The QoS information also includes data related to the QoS features provided such as traffic shaping, etc. The traffic shaping allows a network server to control the traffic going out an interface in order to match its flow to the speed of the remote, target interface and to ensure that the traffic conforms to policies contracted for it. Thus, traffic adhering to a particular profile can be shaped to meet downstream requirements, thereby eliminating bottlenecks in topologies with data-rate mismatches. The primary reasons for implementing the traffic shaping are to control access to available bandwidth, to ensure that traffic conforms to the policies established for it, and to regulate the flow of traffic in order to avoid congestion that can occur when the transmitted traffic exceeds the access speed of its remote, target interface

The HLR further includes charging information such as the type of charge, e.g., a pre-paid charge, a usage charge or a group charge. The charge information further includes balance left for a specific user of the wireless communication services. The HLR further include data related to access point and cell management information. The data includes the AP MAC address, the AP BSSID, the AP ESSID, the cell ID, the location or zone of the cell, the IP address of the cell, the AP manufacture, the software/firmware release number, the AP security features, e.g., WEP, WPA etc., the AP AAA key, the RF channel and power management, and other information related to cell management. The HLR further data records for providing information relates to WLAN system that includes the system IP address, e.g., Lo-0 address, the system name, the DHCP range assignment, the trunk configuration information, and other related information for WLAN system.

When a WLAN server; mobile Visitor Location Register (VLR), e.g., 100-1-VLR, 100-2-VLR or 100-3-VLR, is booted up, data records are downloaded from the master server HLR to the WLAN servers 100-VLR to provide information to the switch as the WLAN Visitor Local Record (VLR). The WLAN VLR, e.g., the switch 100-1-VLR, 100-2-VLR, or 100-3-VLR, then configures the access points (APs) by using the downloaded data to management the entire sub-network. There are two types of data downloaded from the HLR to the switches. The first type of information is related to WLAN system and the switches then apply these types of information to configure the AP to carry out the tasks of cell management and also to manage the entire subnet. The second types of information are the Moble VLR records. The WLAN servers 100-VLR do not store any of the mobile user data in the initial stage. The mobile user turns on WiFI device and tries to register/access to WLAN server. The mobile user data (Mobile user personal data, Mobile cell information, Mobile user security access information, billing information and Mobile user QoS information) are downloaded from the backend server HLR as MLHR record downloaded to the WLAN servers 100-1-VLR to 100-3-VLR as the VLR record. With the VLR record now resides at each WLAN servers that manage the access points, the wireless communication network now provide the connectivity of data and media data, the QoS for mobile users, wireless roaming and billing and usage records over the entire network systems with improved security and reliability.

As described above, when the mobile user turns on the mobile device, it will register itself to WLAN network through the WLAN servers such as servers 100-1-VLR to 100-3-VLR. The mobile user's information is downloaded from HLR (Central management system) to VLR (VLR Local) systems. The VLR will provide the connectivity, QoS, and security service to mobile user at real time. Mobile user roaming among APs in the same WLAN VLR networks the MVLR server will handle mobile device authentication, roaming service.

When the mobile user moves from WLAN MVLR server to other WLAN MVLR server; the new WLAN MVLR server will request HLR to provide mobile user's information. The HLR system will request mobile user usage data from previous WLAN MVLR server, and download the mobile user's data to new WLAN MVLR server. Central HLR system is the database of mobile users. The capacity of HLR is up to 100,000 mobile users data. The HLR can be located in the computer server for large network or scalable system. Also, the HLR can work with VLR in the same WLAN server. The distributed WLAN MVLR server performs the real time management for real time traffic. The distributed WLAN system can be scalable up to 100,000 mobile users and up to 6000 AP systems. The local stand-alone WLAN MVLR server can provide the service to 300 users (1 GigE) to 2000 users (4 GigE).

According to above descriptions and FIGS. 4 to 6, this invention discloses a wireless communication system for interconnecting a plurality of wireless devices registered to the wireless communication system as clients for communicating through multiple layers of message transfer and switch devices organized as a plurality of subnets. The wireless communication system further includes a first server for dynamically and intelligently distributing user profile data records of the clients to a second server to manage at least one of the subnets for each of the clients to apply the user profile data records to communicate through the wireless communication system whereby the wireless communication system may be expanded through sharing and distributing the user profile records. In a preferred embodiment, the user profile data records comprising data records of wireless mobile device MAC addresses used as a key for searching and identifying and recognizing each of the wireless communication devices employed by each of the clients. In another preferred embodiment, the user profile data records comprising data records of personal data for identifying and recognizing each of the clients registered to communicated via the wireless communication device through the wireless communication system. In another preferred embodiment, the user profile data records comprising data records of user access authorization data for identifying and recognizing user access privileges and access zone areas for each of the clients. In another preferred embodiment, the data records of user access authorization data further includes data for identifying and recognizing user allowable access applications for each of the clients. In another preferred embodiment, the user profile data records comprising data records of mobility management for managing a mobility of the clients moving from between subnets of the wireless communication system. In another preferred embodiment, the user profile data records comprising data records of Basic Service Set Identification/Identifier (BSSID), mobile device home Extended Service Set Identification/Identifier (ESSID), and optionally the home VLAND ID associates a frame with a specific VLAN and provides information for switches to process communication frames across the subnets of the wireless communication network. In another preferred embodiment, the user profile data records comprising data records of mobile user quality of service (QoS) information for providing user types and rate for each of the user types. In another preferred embodiment, the user profile data records comprising data records of mobile user quality of service (QoS) information for providing user types and a Premium rate, a Guarantee rate, and a Best Efforts rate for each of the user types. In another preferred embodiment, the user profile data records comprising data records of mobile user quality of service (QoS) information for providing traffic shaping data for managing and controlling wireless communication access in compliance to an access policy of the clients and an available bandwidth of the wireless communication system. In another preferred embodiment, the first server and second server further comprising personal computers (PC) functioning as the servers. In another preferred embodiment, the multiple layers of message transfer and switch devices further includes switches organized into the plurality of subnets. In another preferred embodiment, the multiple layers of message transfer and switch devices further includes switches connecting to a plurality of access points with each of the access points connected to the plurality of wireless communication devices organized into the plurality of subnets. In another preferred embodiment, the wireless communication system further includes a backup server to backup the first serve and ready to handle functions as the first server.

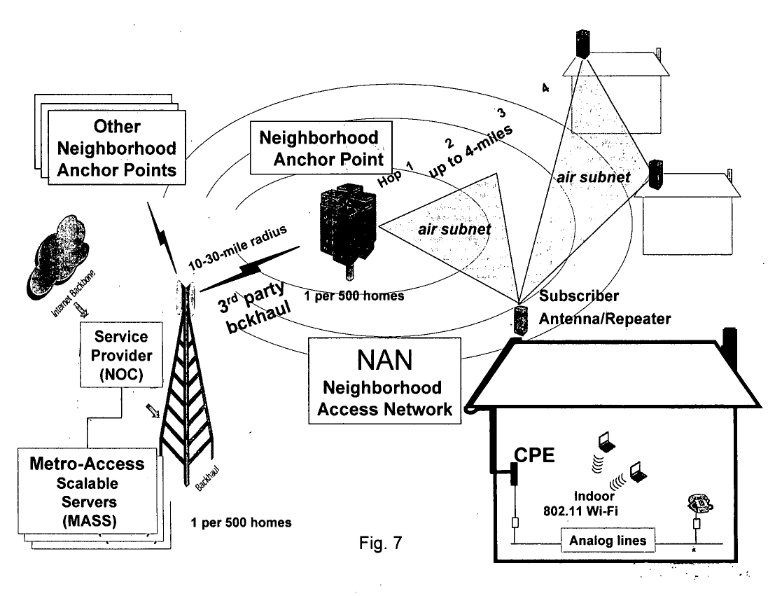

FIG. 7 shows the signal transmissions and network architectures of the wireless local loop implemented as a metro network. There are many benefits provided by the wireless network communication systems. The advantages of distributed and scalable WLAN systems are as followed:
Better performance, no traffic bottleneck.
Cover larger area
N+1 redundancy WLAN-MVLR server. Mirroring coverage of HLR systems.
Flexibility.
Provide the same QoS, security service through entire networks (various WLAN MVLR servers).
   WI-FI Mobility Management with QoS.
a. Mobile users QoS is covered by HLR-VLR across entire networks
b. The mobile QoS is managed by HLR(Layer 7)-VLR (Layer 3). The mobile user QoS information will be downloaded to the various forwarding table. Lower layer (Layer 2) will perform deep packets inspection with QoS actions through the users' traffic.

Mobile user QoS data is provisioned in the HLR and will be downloaded to VLR.

The VLR will calculate the bandwidth usage at real time. The following paragraph describes the algorithm of Moble QoS.

Mobile QoS Algorithm

Total bandwidth (BW) per system=(GigE*number of Trunk+10/100* number of Interface)

Total BW of per trunk (Tbw)=GigE (1G bits/second.). The WLAN system is able to provision the Bandwidth Watermark or Threshold (W, such as 80%) of trunk. When real time traffic of bandwidth usage reaches the threshold (Tw=Tbw*W) the mobile QoS will start to operate. (For example: W=80% of 1 G. Tw=1000 M*0.8=800 M)
1. The VLR will collect the real Time Traffic of downlink trunk periodically. The real time traffic of bandwidth collect at time frame T1 is (Tbw1). The next bandwidth collection is Tbw2
2. Real time rate Trt=(Tbw2−Tbw1)/T
3. If (Trt>=Tw) then (start monitor QoS, QoS counter++)
4. If (QoS counter>5) then (Mobile QoS)

The mobile user Quality of Service type is used to decide the traffic priority. Therefore, the lower priority user's traffic will be dropped. In the WLAN MVLR server the priority of user type is:

Premium (MU)>Guarantee (GU)>Best Effort (AU).

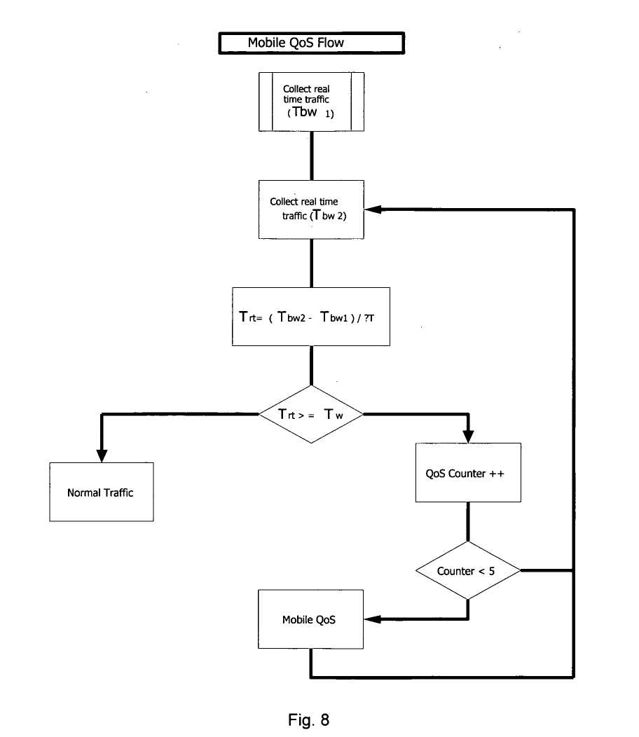

FIG. 8 is a flowchart for showing the steps used to implement the processing steps.

Step 1: The WLAN server will calculate the AU type of traffic and select the highest rate usage user traffic packet to drop. The MU, GU and some of AU traffic will not be impacted.

Step 2: In case 1, all AU type of user traffic have been selectively dropped, but (Trt>=Tw). The GU user will be selectively dropped. The lower rate of GU user will be selected and dropped for the purpose to serve the higher rate user with a higher priority.

Step 3: In case 1 & 2, all AU/GU type of user traffic have been selectively dropped, but (Trt>=Tw). The MU user will be selectively dropped. Repeat the steps 1 through 3 until Trt<Tw and the AU user traffic will come back to normal.

Selective Drop with Rate Prediction:

In the above section describes the packet dropped scenarios when traffic jam is detected. In this section describes the traffic can be managed by the rate history and predict the rate usage of mobile user. The available rate mobile users with predicate rate increase will be selectively dropped. The user rate will be monitored & calculated until the rate usage curve show decrease.
1. Real time rate (T1) Trt=(Tbw2−Tbw1)/T
2. Real time rate (T2) Trt=(Tbw3−Tbw2)/T
3. Rate usage Trt=T2−T1/T
4. Repeat step 1-3
5. If ((Trt 1−Trt)/T)>1 or Trt 1>Trt then start monitor QoS

The step 5 predicates the mobile user rate increase. WLAN MVLR server will dynamic select the AR mobile user with rate increase to dropped packet. In the following conditions QoS operation will be stopped.
a. No more traffic jam. All available users that in the mobile QoS pool will be removed.
b. Mobile user rate usage decrease.
   Air QoS Air QoS Management

The WLAN server will manage all APs performance of entire networks, also, WLAN server will manage mobile user air quality through AP. The WLAN will instruct AP to perform QoS actions if traffic jam is detected.

Currently, the access point 802.11a/g operate as 54 Mbis/s and 802.11b operate as 11 Mbits/s.

The WLAN server will request all the APs to report mobile users that register in the AP (MAC address). Also, WLAN server will collect individual mobile user traffic rate periodically from AP.

AP Total bandwidth: Tapbw

AP operates Rate: Tapop=Tapbw*OPW

Number of MAC users Umac

Basic rate per User is Tbr=Average user rate (such as 2 M bits/second)

Actually AP operate rate Tu=Tapop/Umac

If (Tu<Tbr) then Mobile air QoS operation is required.

Depending on the Mobile User's Quality of Service type the WLAN VLR will decide the priority of traffic.

In the WLAN MVLR server, the priority of user type is:

Premium (MU)>Guarantee (GU)>Best Effort (AU).

Step 1: The WLAN server calculates the AU type of traffic and select the top of rate usage user traffic packet to drop with the VLR searches AP user's MAC address to get user type). The MU, GU and some of AU traffic will not impacted.

1. The WLAN VLR will inform AP to setup MAC in the Denial of Service (DoS) entry or
2. The WLAN VLR will send a message to force mobile user to un-register from AP and move to other low bandwidth usage AP.

Step 2: In case 1, all AU type of user traffic have been selectively dropped, but (Tu<Tbr). The GU user will be selectively dropped. The lower rate of GU user will be selected to be dropped then the higher rate user.

Step 3: In case 1 & 2, all AU/GU type of user traffic have been selectively drop, but (Tu<Tbr). The MU user will be selectively dropped.

Step 4: WLAN VLR monitor the user rate usage statistics data. Some of slow device occupied high percentage of air bandwidth. The WLAN VLR will perform CASE 1 procedure to improve air bandwidth usage.

Repeat the procedures 1 through 3 until Tu>Tbr and the AU user traffic will come back to normal.

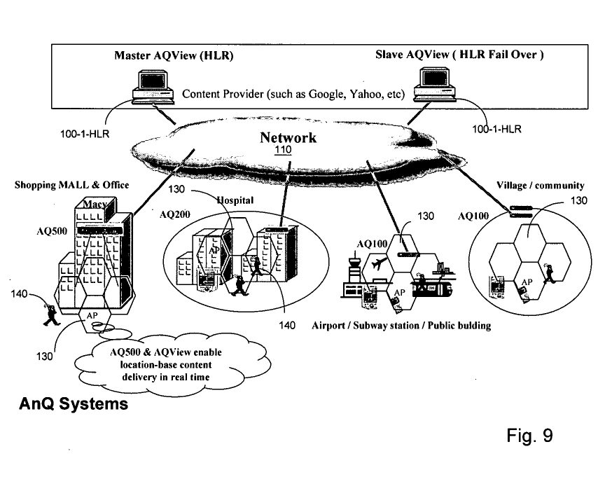

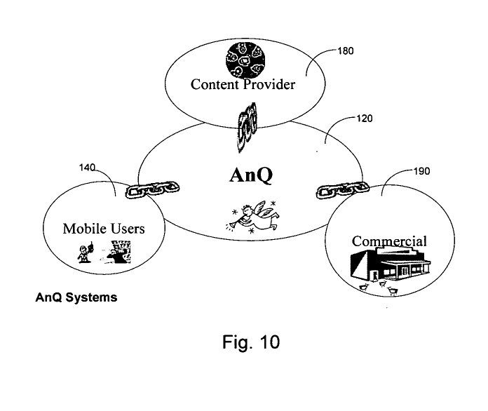

Referring to FIG. 9 for a content delivery operation enabled by a WLAN communication system described in this invention. As shown in FIG. 10, when a mobile user walks into a shopping mall and entering into a store, e.g., Macy's. A AP 140 automatically detect the entry of a mobile user with a unique mobile user ID and all related information available through a VLR record and HLR record managed by a master server 100-1-HLR and optionally through another layer of 100-VLR WLAN servers as shown in FIG. 5. The VLR records enable a subnet AP 130 to detect and recognize a particular user. The detection and recognition of a user ID would allow a content provider to push content related to particular location when a mobile is detected and recognized in a particular location. For instance, a mobile user can register with a content provider such as Yahoo, AOL to receive selected kinds of information related to locations, e.g., store coupons, store advertisements, flight numbers, weather data at particular locations, etc. At the entry and detection of such mobile user at selected location, e.g., a mobile user entering into Macy's store, the content provider then automatically delivers, i.e., pushes, Macy's store coupons to the mobile user into a cellular phone or a PDA. Alternately, a mobile user may request through the local AP for location specific information, i.e., information pulling operation, once a communication is detected and established. FIG. 10 is a functional block diagram for showing the cooperation between the content providers, e.g., Yahoo, Google, AOL, etc., a commercial entity, Macy's, Safeway, Sears, etc., and a mobile user through the communication network systems as disclosed in this invention that can detect and recognize a mobile user at designated locations to deliver location specific data and information.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention. Those approaches and mechanisms in the art will appreciate variations of the above-described embodiments that fall within the scope of the invention. As a result, the invention is not limited to the specific examples and illustrations discussed above, but only the following claims and their equivalents.

I claim:

1. A wireless communication system for interconnecting a plurality of wireless devices registered to said wireless communication system as clients for communicating through multiple layers of message transfer and switch devices organized as a plurality of subnets, said wireless communication system further comprising:
a first server for dynamically and intelligently distributing user profile data records of said clients to a second server to manage at least one of said subnets for each of said clients to apply said user profile data records to communicate through said wireless communication system whereby said wireless communication system may be expanded through sharing and distributing said user profile records.

2. The wireless communication system of claim 1 wherein:
said user profile data records comprising data records of wireless mobile device MAC addresses used as a key for searching and identifying and recognizing each of said wireless communication devices employed by each of said clients.

3. The wireless communication system of claim 1 wherein:
said user profile data records comprising data records of personal data for identifying and recognizing each of said clients registered to communicated via said wireless communication device through said wireless communication system.

4. The wireless communication system of claim 1 wherein:
said user profile data records comprising data records of user access authorization data for identifying and recognizing user access privileges and access zone areas for each of said clients.

5. The wireless communication system of claim 4 wherein:
said data records of user access authorization data further includes data for identifying and recognizing user allowable access applications for each of said clients.

6. The wireless communication system of claim 1 wherein:
said user profile data records comprising data records of mobility management for managing a mobility of said clients moving from between subnets of said wireless communication system.

7. The wireless communication system of claim 1 wherein:
said user profile data records comprising data records of Basic Service Set Identification/Identifier (BSSID), mobile device home Extended Service Set Identification/Identifier (ESSID), and optionally the home VLAND ID associates a frame with a specific VLAN and provides information for switches to process communication frames across said subnets of said wireless communication network.

8. The wireless communication system of claim 1 wherein:
said user profile data records comprising data records of mobile user quality of service (QoS) information for providing user types and rate for each of said user types.

9. The wireless communication system of claim 1 wherein:
said user profile data records comprising data records of mobile user quality of service (QoS) information for providing user types and a Premium rate, a Guarantee rate, and a Best Efforts rate for each of said user types.

10. The wireless communication system of claim 1 wherein:
said user profile data records comprising data records of mobile user quality of service (QoS) information for providing traffic shaping data for managing and controlling wireless communication access in compliance to an access policy of said clients and an available bandwidth of said wireless communication system.

11. The wireless communication system of claim 1 wherein:
said first server and second server further comprising personal computers (PC) functioning as said servers.

12. The wireless communication system of claim 1 wherein:
said multiple layers of message transfer and switch devices further includes switches organized into said plurality of subnets.

13. The wireless communication system of claim 1 wherein:
said multiple layers of message transfer and switch devices further includes switches connecting to a plurality of access points with each of said access points connected to said plurality of wireless communication devices organized into said plurality of subnets.

14. The wireless communication system of claim 1 further comprising:
a backup server to backup said first serve and ready to handle functions as said first server.

15. A wireless communication system comprising multiple data handling systems for processing network connections and data transmissions between different data handling systems; wherein:
one of said data handling system functioning as a centralized data handling system for dynamically and intelligently distributing a user profile data record to one of said data handling systems whereby each of said data handling system is enabled to process said network connections and data transmission in real time for handling a wireless communication for a user designated by said user profile data record.

16. The wireless communication system of claim 15 wherein:
said data handling systems further comprising personal computer (PC) based servers.

17. The wireless communication system of claim 15 wherein:
each of said data handling systems further comprising a network communication interface for networking and communication with another data handling system.

18. The wireless communication system of claim 15 wherein:
said data handling systems further comprising standard network communication switches.

19. The wireless communication system of claim 15 wherein:
said data handling systems further comprising standard thin access point (AP) processors.

20. The wireless communication system of claim 15 wherein:
one said data handling systems further functioning as a backup centralized data handling system for providing a backup to said centralized data handling system.

21. The wireless communication system of claim 15 wherein:
said data handling systems further comprising standard thin access point (AP) processors and each of said thin AP processors is employed for connecting to a wireless client through a nearby thin AP processor; and
said nearby thin AP processor is enabled for dynamically receiving said user profile data record of said wireless client immediately following said wireless client logging in said wireless communication system through said nearby thin AP processor.

22. A method for providing a client-requested location dependent information for a designated location through a wireless communication system, the method comprising:
detecting a presence of a wireless network client at the designate location by the wireless communication system wherein the wireless communication system includes a data record of client profile to enable a determination if there is such a client-requested location dependent information for the designated location from the user whereby the client-requested location dependent information may be provided to the client at the designated location through the wireless communication system.
